(19) United States
(12) Patent Application Publication
(10) Pub. No.: US 2021/0044497 A1
(43) Pub. Date: Feb. 11, 2021

(54) HYBRID APPROACH FOR RATE LIMITING IN DISTRIBUTED SYSTEMS

(71) Applicant: VISA INTERNATIONAL SERVICE ASSOCIATION, San Francisco, CA (US)

(72) Inventor: Ranglin Lu, Austin, TX (US)

(73) Assignee: VISA INTERNATIONAL SERVICE ASSOCIATION, SAN FRANCISCO, CA (US)

(21) Appl. No.: 16/537,409

(22) Filed: Aug. 9, 2019

(51) Int. Cl. H04L 12/24; H04L 12/911

(52) U.S. Cl. CPC H04L 41/5019; H04L 47/82

(57) ABSTRACT

A system and computer-implemented method for enforcing parameters of resource consumptions. A controller receives, via a node in a distributed computer network, a request from a requester for one of services to be provisioned by a plurality of servers. The plurality servers are accessible via the distributed computer network. The controller identifies parameters of resource consumption from a data store of the plurality of servers in the distributed computer network system as a function of outstanding requests from requesters. The controller determines if the parameters of resource consumption is less than a resource threshold. If the determination is positive, controller compares the request to a total number of requests before accepting the request. If the determination is negative, the controller compares the request to the parameters divided by a number of nodes before accepting. The controller schedules the accepted request for execution.

### TECHNICAL FIELD

Embodiments discussed herein generally relate to resource provisioning and balancing.

### BACKGROUND

Web service providers for various industries have frequently used distributed network configurations to provide services to users around the global to achieve efficiency in managing resources and convenience in delivering services to the users. Most of the services are responded relatively quickly (e.g., serving web pages to page requests from users). For more intensive resource needs, such as web services that provide data access and storage for web site customers, web service providers may dedicate certain groups or clusters of servers for these web site customers. In addition, web service providers may use a manager or a controller to schedule and manage the requests and therefore resources in serving the customers.

At times, however, there may be different needs from customers that may complicate the requests and therefore the reallocation of resources for web service providers. These complications involve geographic locations, nature of the requests and sometimes service level agreements (SLAs) between the providers and customers.

For example, existing practices take a local approach and a central approach in handling and processing of resource requests. In one example, the central approach involves when a node in the distributed computer network receives a request from a requester, the node reports the request to a central service such as a manager or a controller. The central service reviews the request against the number of requests from all nodes to decide if the request is over a certain threshold or limit. This approach has the advantage of having the central service know the accuracy of request loads and thus avoid overloading or not meeting the completion requirements of a given request. The disadvantage is that this approach adds more latency and complexity to the management.

The other common approach is a local approach: when a node in the distributed computer network receives a request, the node checks against the number of requests it has received to see if the number exceeds the total rate limit policy divided by the number of nodes. The advantage is that there would be no latency. However, the disadvantage is that the accuracy of the rate limit or threshold is poor because the number of nodes available for processing the requests can change at moment's notice and that the distribution of requests may not be evenly.

Therefore, embodiments attempt to create a technical solution to address the deficiencies of the challenges above.

### SUMMARY

Embodiments create a technical solution to the above challenges by modifying or updating the existing approaches. Aspects of embodiments enable an improved capability to enforce the rate limiting policies and the SLAs. In one embodiment, when a rate limit is low or the SLA is long, the central approach may be employed to limit CPU, Memory and I/O intensive requests. In another embodiment, when the rate limit is high or the SLA is short, the local approach may be employed to protect the system from high rate of quests. Moreover, aspects of embodiments may address the accuracy issues (e.g., due to change of number of nodes) by discovering service status at each node so that each node may know how many nodes are currently active and local rate limit may be calculated dynamically. Moreover, aspects of embodiments enable switching or changing thresholds as defined by rate or SLA requirements.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a system diagram for flexible managing or controlling of resource usage according to one embodiment.

FIG. 2 is a flowchart illustrating a computerized method according to one embodiment.

FIG. 3 is a diagram illustrating one or more parameters for responding to a service request according to one embodiment.

FIG. 4 is a diagram illustrating a portable computing device according to one embodiment.

FIG. 5 is a diagram illustrating a computing device according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Embodiments create a dynamic and flexible controlling or management of resource usage. When a rate limit is low or the SLA is long, the central approach may be employed to limit CPU, Memory and I/O intensive requests. In another embodiment, when the rate limit is high or the SLA is short, the local approach may be employed to protect the system from high rate of quests. Moreover, aspects of embodiments may address the accuracy issues (e.g., due to change of number of nodes) by discovering service status at each node so that each node may know how many nodes are currently active and local rate limit may be calculated dynamically. Moreover, aspects of embodiments enable switching or changing thresholds as defined by rate or SLA requirements.

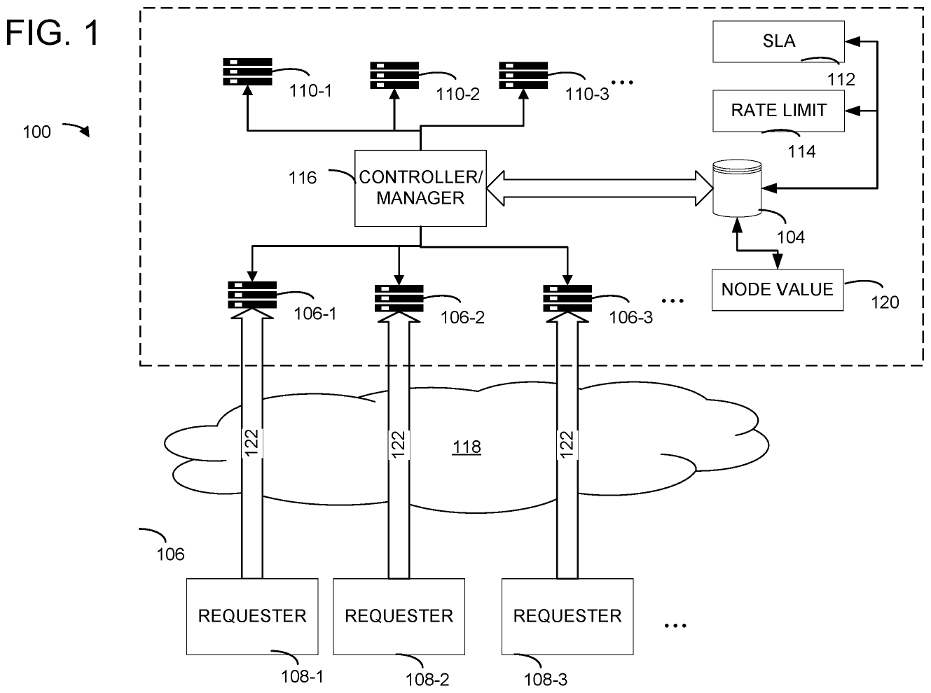

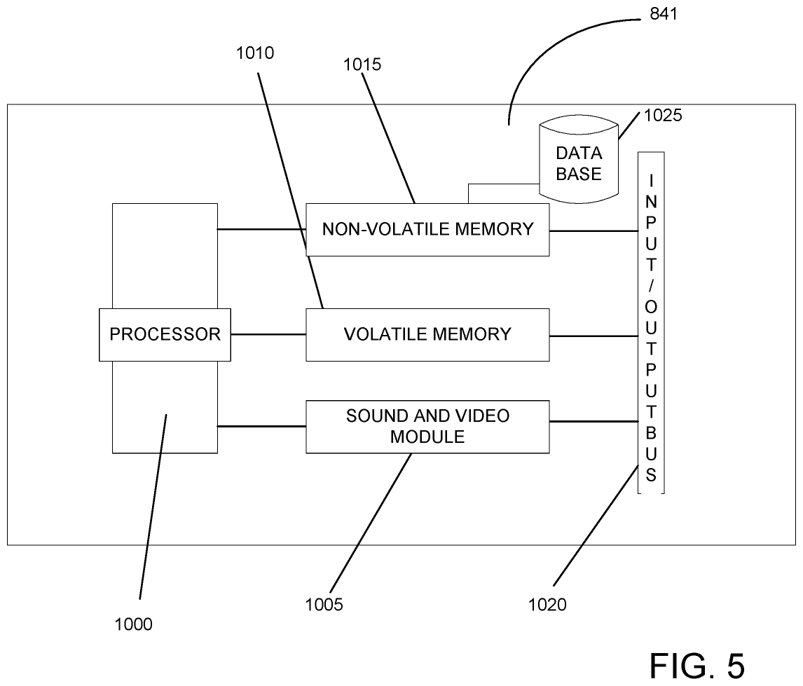

Referring now to FIG. 1, a diagram illustrates a system 100 for flexible managing or controlling of resource usage according to one embodiment. In one embodiment, the system 100 may be include a cluster of servers comprising computing devices such as a computing device 841 illustrated in FIG. 5. In another embodiment, the cluster of computing devices may be arranged in a distributed manner across a computer network 102. For example, the cluster of computing devices may be spread across geographic regions. In another embodiment, the system 100 may also include database servers 104 that store data or provide storage needs for the system 100.

The clusters of servers in the system 100 may be arranged in a number of ways. For illustrative purposes and not as a limitation, the system 100 may arrange one or more nodes 106 as a front end nodes that receive requests from requesters 108. In one embodiment, the nodes 106 may be server endpoints of the system 100. In another embodiment, the requesters 108-1, 108-2, and 108-3 may be computing devices communicating directly with the system 100. In another embodiment, the requesters 108 may employ proxy servers or aggregator services that send requests to the system 100. In one example, the requesters 108 may request services from the system 100. In another example, the requesters 108 may be server endpoints and not client nodes. For example, the system 100 may be part of a payment processing network, and the system 100 may provide a variety of services to the requesters 108, such as payment transaction processing, payment data analysis, and payment data enhancement services. As such, the system 100, with the cluster of servers, may utilize all the resources from the cluster of servers and the database servers 104. In addition, the system 100 may include additional servers 110 that may be considered as nodes for the back end processing. However, it is to be understood that the nodes 106 and 110 may be used interchangeably without departing from the scope and spirit of aspects of embodiments. In other words, the nodes 106 may perform backend processing while the nodes 110 may perform front end request handling as well.

In one embodiment, the system 100 may employ artificial intelligence (AI) as part of the services to the requesters 108. In one embodiment, an AI engine may be installed in the system 100 to more efficiently configure the nodes 106 and 110. For example, the AI engine may study the past SLA or rate limiting policies by using them as training models so that the AI engine may suggest to the cluster of servers about how to configure or set the rate limits in the rate limiting policy or the SLA. In another embodiment, the AI engine may also configure the identifying of the potential level of the request from the requesters 108. For example, the AI engine may suggest to the system 100 that a particular requester 108 may likely send requests with low rate limit or long SLA at a given period so that the system 100 may adaptively adjust its resources to accommodate to the requester's request.

According to one aspect, the requesters 108 may establish a service level agreement (SLA) with the system 100 to establish a relationship and expectation between the requesters 108 and the system 100, a service provider. For example, the SLA may describe the system 100's commitments for uptime of its servers and connectivity between the various components and devices within the system 100 as provided by its hardware devices. In one example, the hardware devices may include the cluster or clusters of servers, database servers, network equipment, central processing unit (CPU), graphics processing unit (GPU), memory units, etc. In another embodiment, the SLA may define further granularity to requests at the level of applications that request the services.

In another embodiment, the requesters 108 may request the services from the system 100 via application programming interface (API), such as via API calls. To satisfy the needs of the requesters 108 per SLA, the system 100 may need to control or manage the requests efficiently so as to provide timely responses to the requesters 108 but also maintain acceptable loads on the resources.

In one embodiment, the system 100 may define or configure a rate limiting policy or rate limiting policies 114 based on a SLA, such as SLA 112 with the requesters 108. In one embodiment, the rate limiting policy 114 may restrict a number of requests by an application from of the requesters 108 (e.g., the requester 108-1). In another embodiment, the rate limiting policy 114 may be client-ID based such that requests from a client-ID may be restricted based on the rate limiting policy 114. For example, the system 100 may assign a client-ID to a requester and provide token credentials in a form of query parameters.

Given the limited resources the system 100 has, the system 100 may employ a request handler, controller, or manager 116 (hereinafter “controller” for short) to control or manage the requests. The controller 116 may be an application executable by the cluster of servers 106. In another embodiment, the controller 116 may be a dedicated server with application software designed to handle the task of controlling or managing the requests. In a further embodiment, the controller 116 may be a cluster of servers in a distributed network, such as the network 118.

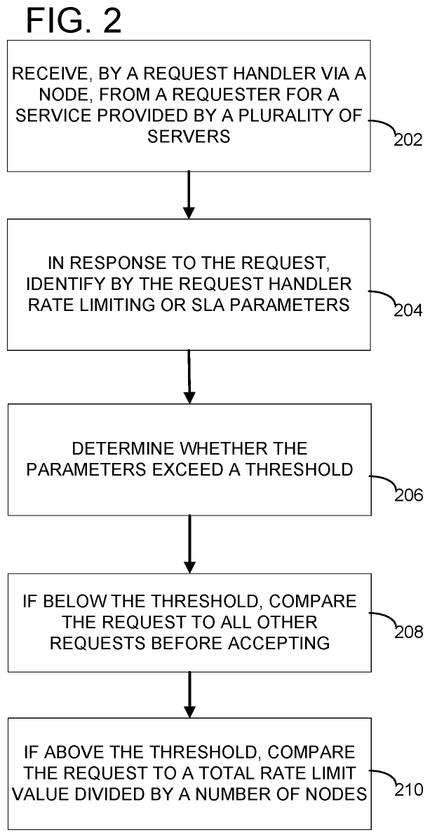

Referring now to FIG. 2, a flow chart illustrates a computer-implement method of aspects of embodiments. In one embodiment, the nodes 106 may first receive a request 122 from the requester 108-1 request a service from the system 100 at 202. In one embodiment, the nodes 106 and the requesters 108 may have a one-to-one relationship so that the nodes 106 may be configured to handle requests from the requesters 108 more efficiently. As discussed with the SLA 112 above, the system 100 may assign one or more nodes 116 to handle specific requesters 108.

Upon receiving the request 122, the node (e.g., 106-1) may forward to the request 122 to the controller 116 for management. In one embodiment, the controller 116 may first identify a rate limit policy (e.g., the rate policy 114) or the SLA 112 to determine the resource availability at 204. For example, the controller 116 may review the databases 104 to identify any parameters from the rate limiting policy 114 or the SLA 112 for the particular kind of request or the requests from the requesters 108. In one embodiment, the request 122 may include parameters such as client ID or token authentication assigned to the particular requester. In another embodiment, the rate limiting policy 114 may identify that the limit is low. For example, a low rate limit may indicate that the request may consume higher amount of resources, so to limit overloading of the resources, the rate limit may be low. In another embodiment, the rate limiting 114 may also be determined by the number of nodes available for processing the request. For example, a number of node parameters may be available for the controller 116 to review before determining or calculating the rate limiting from the rate limiting policy 114.

In another embodiment, the SLA 112 may be “long” or extensive, which may indicate that more complicated tasks or workloads are required. In a further embodiment, the SLA 112 may also include a timing parameter, which may specify how much time the system 100 has to complete the request. In another embodiment, the SLA 112 may be set as automatic, meaning that all requests are approved. As such, the controller 116 may configure a rate limit for such kind of SLA 112 at high due to the need for less intensive loads.

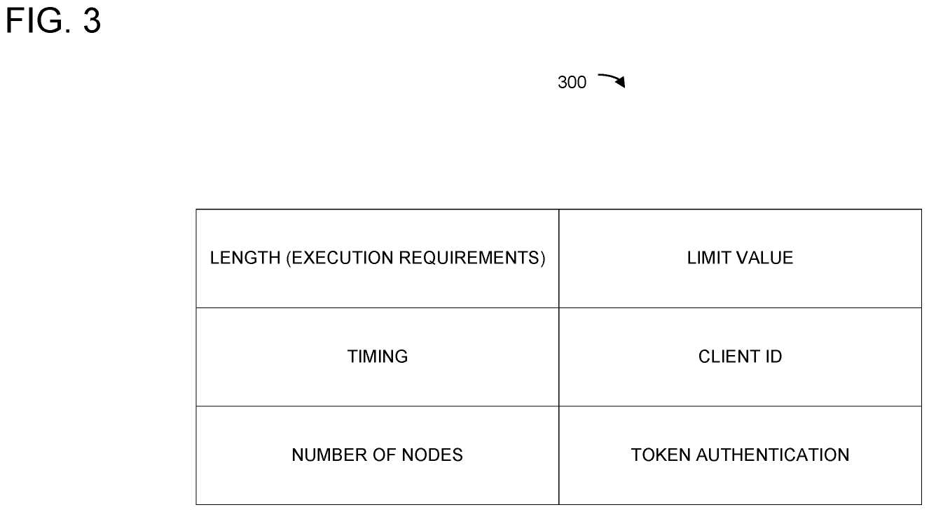

It is to be understood that one or more parameters other than those shown in FIG. 3 may be included without departing from the scope and spirit of aspects of embodiments. For the example, the controller 116 may configure parameters such as location, node ID, etc., to further manage the request responses.

At 206, in response to identifying the parameters, the controller 116 may determine whether the parameters identified exceed a threshold. For example, the controller 116 may compare the rate limit value of the rate limiting policy 114 or the length of the SLA 112 with the threshold. In one embodiment, if the controller 116 determines that the rate limit value or the length of the SLA 112 does not exceed the threshold (e.g., rate limit is low or the SLA is long), at 208, the controller 116 may compare the request with other requests received by all nodes, such as nodes 106 and 110, in the system 100 to accept the request 122. Such approach may provide better accuracy of the execution even though it introduces some latency due to the fact that the controller 116 may need time to determine the acceptance based on the comparison. However, due to the complexity involved with the request, the need to ensure that the request is performed according to the rate limiting policy and the SLA is of a higher priority.

On the other hand, if the rate limit value or the length of SLA 112 exceeds the threshold (e.g., rate limit is high or the SLA is short), at 210 the controller 116 may compare the request 122 with a number of requests as a function of a total rate limit policy values divided by the number of nodes before accepting the request.

In another aspect, the controller 116 may profile the request 122 based on AI algorithms. For example, the controller 116 may review historical data from the databases 104 to determine that requester 108-3 typically may send high frequency but low intensity requests. As such, the controller 116 may dynamically adjust the rate limit value high or threshold low so as to be able to accept the request without issues. On the other hand, if the controller 116 has identified a certain node (e.g., node 106-2) typically sends that tasks or loads that require fast turnaround time and long SLA, the controller 116 may dynamically adjust the rate limit value to ensure the other tasks from other requesters' may not interfere with the completion of the request from the node 106-2.

In a further embodiment, the controller 116 further maintain a profile or profiles of requests to better manage or enforce the rate limit and the SLAs to safeguard resources of the system 100. The controller 116 may dynamically configure or modify the rate limit based on the number of nodes available in the system to process and execute the request 122. Such approach provides flexibility but also balancing accuracy and latency in accepting the request while rejecting others.

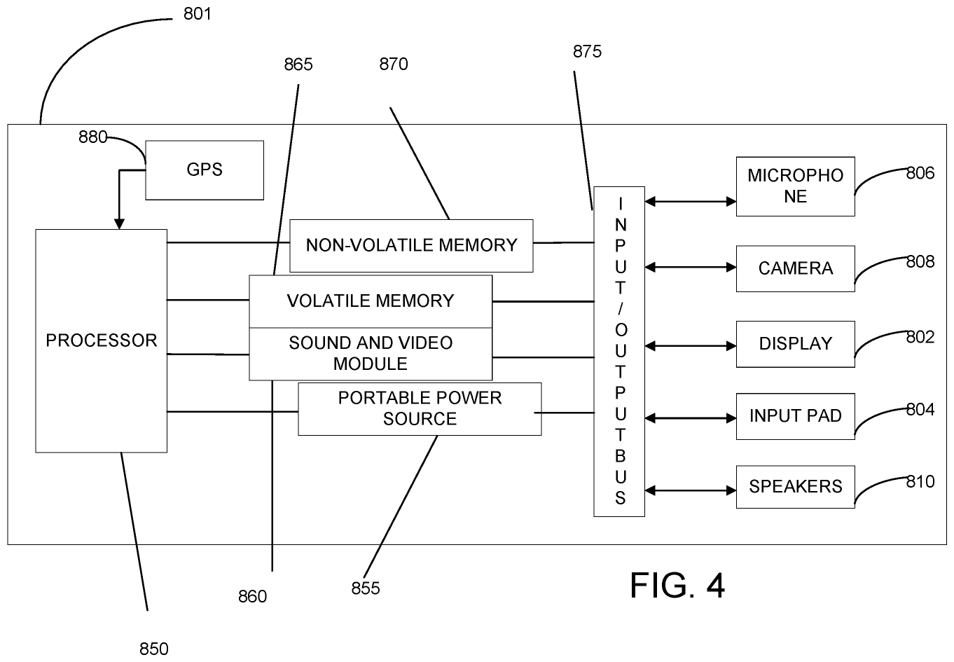

FIG. 4 may be a high level illustration of a portable computing device 801 communicating with a remote computing device 841 in FIG. 5 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc., FIG. 4 may be a simplified illustration of the physical elements that make up a portable computing device 801 and FIG. 5 may be a simplified illustration of the physical elements that make up a server type computing device 841.

FIG. 4 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have non-volatile memory 865 and volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc., It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 5. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc., The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (e.g., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods overcome challenges dealing with the inability to update the latest encryption or cryptographic content associated with a third-party hosted resource. However, aspects of embodiments maintain the URL syntax without disturbing established protocol. Instead, embodiments change the flow of accessing the resource so that the content authors may send to the requester the latest version of the resource with the updated encryption or cryptographic content.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

1: A computer-implemented method comprising:
receiving, by a request handler via a node in a distributed computer network, a request from a requester for one of services to be provisioned by a plurality of servers, wherein the plurality servers are accessible via the distributed computer network;
identifying, by the request handler, parameters of resource consumption from the request, wherein the parameters of resource consumption comprise one or more of the following: parameters based on a rate limiting policy, parameters based on a service level agreement (SLA), parameters based on the requester, and parameters based on outstanding requests from requesters, wherein the outstanding requests from the requesters include requests yet to be executed and requested currently in execution;
determining the parameters of resource consumption is less than a resource threshold;
if the determining is positive, comparing the request to a total number of requests before accepting the request; or
if the determining is negative, comparing the request to the parameters divided by a number of nodes before accepting; and
scheduling, by the request handler, the request for execution.

2: (canceled)

3: The computer-implemented method of claim 1, further comprising adjusting, by the request handler, one of the parameters in response a SLA of the requesters.

4: The computer-implemented method of claim 1, further comprising creating a request profile based on historical data.

5: The computer-implemented method of claim 4, further comprising adjusting the parameters of the resource consumption as a function of the request profile for a particular request from a particular requester.

6: The computer-implemented method of claim 4, further comprising dynamically determining a local parameter for the node in the request profile.

7: A computer-implemented method comprising:
receiving, by a controller via a node in a distributed computer network, a request from a requester for one of services to be provisioned by a plurality of servers, wherein the plurality servers are accessible via the distributed computer network;
identifying, by the controller, parameters of resource consumption from the request, wherein the parameters of resource consumption comprise one or more of the following: parameters based on a rate limiting policy, parameters based on a service level agreement (SLA), parameters based on the requester, and parameters based on outstanding requests from requesters, wherein the outstanding requests from the requesters include requests yet to be executed and requested currently in execution;
determining the parameters of resource consumption is less than a resource threshold;
in determining is positive, comparing the request to a total number of requests before accepting the request; or
if determining is negative, comparing the request to the parameters divided by a total number of nodes before accepting, wherein comparing further comprises dynamically determining a local parameter for the node for execution after determining the total number of nodes; and
scheduling, by the controller, the request for execution.

8: (canceled)

9: The computer-implemented method of claim 7, further comprising adjusting, by the controller, one of the parameters in response a SLA of the requesters.

10: The computer-implemented method of claim 7, further comprising creating a request profile based on historical data.

11: The computer-implemented method of claim 10, further comprising adjusting the parameters of the resource consumption as a function of the request profile for a particular request from a particular requester.

12: The computer-implemented method of claim 10, further comprising dynamically determining a local parameter for the node in the request profile.

13: (canceled)

14: A system comprising:
a plurality of servers configured to provide services to a requester;
wherein the plurality of servers comprise a node for accepting a request sent over a distributed computer network;
a controller configured to manage resources of the plurality of servers, wherein the controller is configured to execute computer-executable instructions for:
receiving via the node in the distributed computer network, the request from a requester for one of services to be provisioned by the plurality of servers, wherein the plurality servers are accessible via the distributed computer network;
identifying, by the controller, parameters of resource consumption from the request, wherein the parameters of resource consumption comprise one or more of the following: parameters based on a rate limiting policy, parameters based on a service level agreement (SLA), parameters based on the requester, and parameters based on outstanding requests from requesters, wherein the outstanding requests from the requesters include requests yet to be executed and requested currently in execution;
determining the parameters of resource consumption is less than a resource threshold;
in determining is positive, comparing the request to a total number of requests before accepting the request; or
if determining is negative, comparing the request to the parameters divided by a total number of nodes before accepting; and
scheduling the request for execution.

15: (canceled)

16: The system of claim 14, wherein the controller is further configured to adjust one of the parameters in response a SLA of the requesters.

17: The system of claim 14, wherein the controller is further configured to create a request profile based on historical data.

18: The system of claim 17, wherein the controller is further configured to adjust the parameters of the resource consumption as a function of the request profile for a particular request from a particular requester.

19: The system of claim 17, wherein the controller is further configured to dynamically determine a local parameter for the node in the request profile.

20: The system of claim 17, wherein the controller is further configured to dynamically determine a local parameter for the node after determining the total number of nodes.
